(19) United States
(12) Patent Application Publication
(10) Pub. No.: US 2010/0088595 A1
(43) Pub. Date: Apr. 8, 2010

(54) Method of Tracking Touch Inputs

(76) Inventors: Chen-Hsiang Ho, Hsin-Chu (TW); Yu-Min Hsu, Hsin-Chu (TW); Chia-Feng Yang, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/244,780

(22) Filed: Oct. 3, 2008

(51) Int. Cl. G06F 3/01

(52) U.S. Cl. 715/702; 715/863

(57) ABSTRACT

For a multitouch input configuration, tracking touch inputs includes calculating a first center position corresponding to two touch points along a first axis for a first frame, detecting variation of the first center position from the first frame to a second frame, and determining a gesture type according to the variation of the first center position.

### BACKGROUND OF THE INVENTION

1. Field of the Invention

The present invention relates to touch input devices, and more particularly, to a method of tracking touch inputs for a multitouch input device.

2. Description of the Prior Art

Input devices that interface with computing devices provide means for digitizing and transferring text, images, video, and also commands, according to control by a user. A keyboard may be utilized for transmitting text in a sequence dictated by keystrokes made by the user. A webcam may capture sequences of images, and transfer the images to the computing device for processing and storage. A mouse may be utilized to operate the computing device, allowing the user to point at and click on graphical controls, such as icons, scroll bars, and menus.

Touchpads are input devices which detect physical contact, and transfer coordinates thereof to the computing device. For example, if the user taps the touchpad, coordinates corresponding to the center of an area touched by the user, along with duration of the tap, may be transferred to the computing device for controlling the computing device. Likewise, if the user drags his/her finger in a path along the surface of the touchpad, a series of coordinates may be transferred to the computing device, such that the computing device may discern direction of motion of the user's finger, and respond with an appropriate action.

Previously, touchpad input devices were limited to tracking contact from one source, such as contact from one finger or a stylus. However, simultaneous tracking of multiple points of contact, known as “multitouch,” is rapidly becoming a feasible technology. Popular commands typically associated with multitouch input devices include zooming and rotating. For example, by contacting the multitouch input device with two fingers, and bringing the two fingers together, the user may control the computing device to zoom out. Likewise, by moving the two fingers apart, the user may control the computing device to zoom in.

Please refer to FIG. 5, which is a diagram of a multitouch input captured by a mulitouch device. To detect contact, the multitouch device may include an array of sensors, each sensor corresponding to a row and a column. For example, each row of sensors may form a channel along a Y axis, and each column of sensors may form a channel along an X axis. Then, each sensor may generate a signal in response to the contact, and the signal may be read out as a response on the X axis and a response on the Y axis. For a single input, only one response, or cluster of responses, will be detected on each axis. However, as shown in FIG. 5, for multiple inputs, virtual touched positions will be generated in addition to finger touches. In other words, the multitouch input cannot be utilized to distinguish the finger touches from the virtual touch positions.

### SUMMARY OF THE INVENTION

According to one embodiment of the present invention, a method of tracking touch inputs comprises calculating a first center position corresponding to two touch points along a first axis for a first frame, detecting variation of the first center position from the first frame to a second frame, and determining a gesture type according to the variation of the first center position.

According to another embodiment of the present invention, a method of tracking touch inputs comprises calculating a first center position corresponding to two touch points along a first axis for a first frame, detecting variation of the first center position from the first frame to a second frame, calculating a second center position corresponding to the two touch points along a second axis for a first frame, detecting variation of the second center position from the first frame to the second frame, and determining a zoom gesture type when the variation of the first center position and the variation of the second position are both lower than a predetermined threshold.

According to the embodiments of the present invention, a touch input tracking device comprises a receiving module, a center point calculation module, and a gesture determination module. The receiving module is for receiving a first frame and a second frame. The center point calculation module is for calculating a first center point and a second center point of two touch points in the first frame and the second frame, the first center point corresponding to a first axis and the second center point corresponding to a second axis. The gesture determination module is for determining a gesture type according to variation of the first center point from the first frame to the second frame, and variation of the second center point from the first frame to the second frame.

According to the embodiments of the present invention, a computer system comprises a touch input tracking device, a communication interface, a display, and a processor. The touch input tracking device comprises a receiving module, a center point calculation module, and a gesture determination module. The receiving module is for receiving a first frame and a second frame. The center point calculation module is for calculating a first center point and a second center point of two touch points in the first frame and the second frame, the first center point corresponding to a first axis and the second center point corresponding to a second axis. The gesture determination module is for determining a gesture type according to variation of the first center point from the first frame to the second frame, and variation of the second center point from the first frame to the second frame. The communication interface is for receiving the gesture type from the gesture determination module. The processor is for modifying an image according to the gesture type and driving the display to display the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process for tracking touch inputs.

FIG. 2 is a flowchart of a second process for tracking touch inputs.

FIG. 3 is a diagram of a touch input tracking device.

FIG. 4 is a diagram of a computer system utilizing the touch input tracking device of FIG. 3.

FIG. 5 is a diagram of a multitouch input captured by a mulitouch device.

FIG. 6 is a diagram illustrating detecting change of position for multiple inputs in a multitouch device through midpoint calculations.

FIG. 7 to FIG. 10 are diagrams illustrating detecting change of position for multiple inputs in a multitouch device through component changes.

FIG. 11 to FIG. 16 are diagrams illustrating detecting change of position for multiple inputs in a multitouch device through midpoint shifts.

FIG. 17 is a diagram of tracking touch inputs according to an embodiment of the present invention.

### DETAILED DESCRIPTION

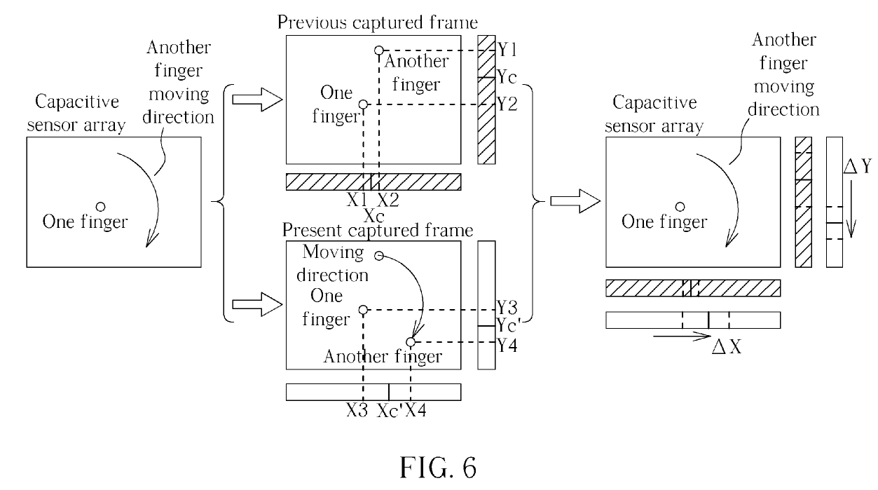

Please refer to FIG. 6, which is a diagram illustrating detecting change of position for multiple inputs in a multitouch device through midpoint calculations. A capacitive sensor array may be utilized to detect touch points made by a first input, labeled “One finger,” and a second input, labeled “Another finger.” Initially, in a previously captured frame, the first input is at a first position <X1,Y2>, and the second input is at a second position <X2,Y1>. After the second input is moved, in a presently captured frame, the second input is at a third position <X4,Y4>, and the first input remains near the first position at a fourth position <X3,Y3>. In each frame, center positions may be calculated. For instance, in the previously captured frame, a first center position <Xc,Yc> may be calculated. The first center position <Xc,Yc> may be calculated as a midpoint of the first position and the second position, e.g. <Xc,Yc>=<(X1+X2)/2,(Y1+Y2)/2>. Likewise, in the presently captured frame, a second center position <Xc′,Yc′> may be calculated. The second center position <Xc′,Yc′> may be calculated as a midpoint of the third position and the fourth position, e.g. <Xc′,Yc′>=<(X3+X4)/2,(Y2+Y4)/2>. Then, utilizing the first center position <Xc,Yc> and the second center position <Xc′,Yc′>, a first variation ΔX and a second variation ΔY from the first center position to the second center position may be calculated. In other words, the first variation ΔX may represent change along the X-axis from the previously captured frame to the presently captured frame of the midpoint between the first input and the second input. Likewise, the second variation ΔY may represent change along the Y-axis from the previously captured frame to the presently captured frame of the midpoint between the first input and the second input. The first variation ΔX may be calculated as ΔX=Xc′−Xc, whereas the second variation ΔY may be calculated as ΔY=Yc′−Yc.

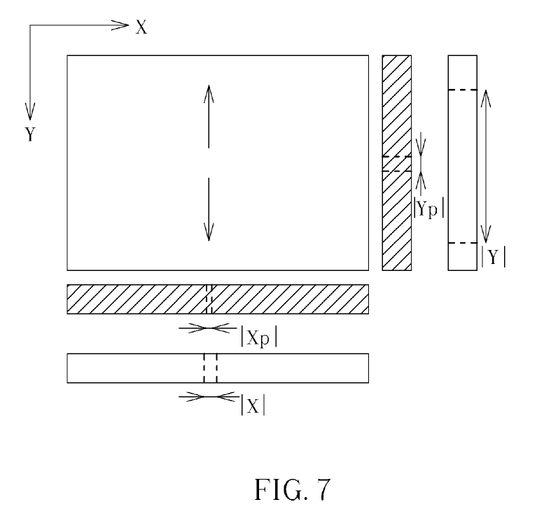

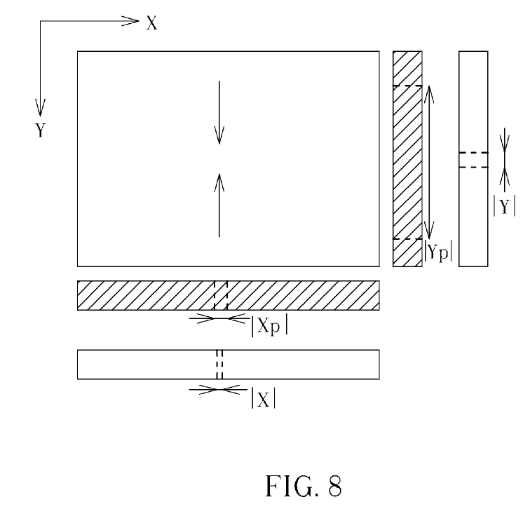

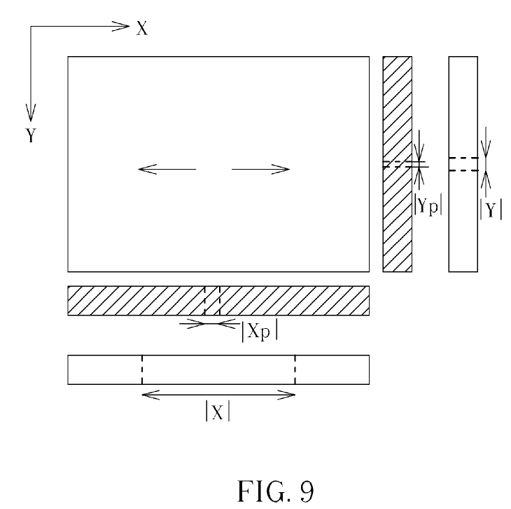

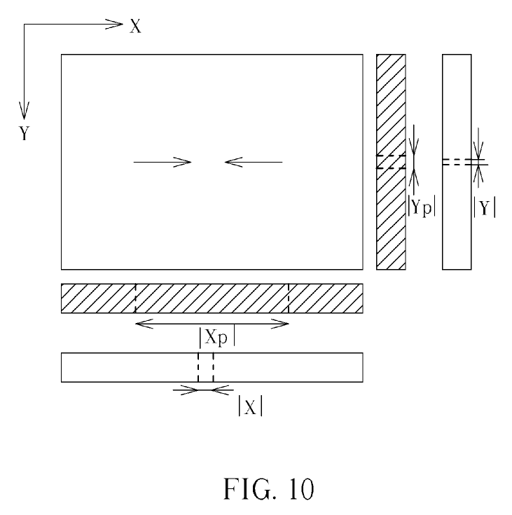

Please refer to FIG. 7 to FIG. 10, which are diagrams illustrating detecting change of position for multiple inputs in a multitouch device through component changes. As shown in FIG. 7, if the first input and the second input are drawn apart along the Y-axis, a first Y-axis difference |Yp| between the first input and the second input may be calculated for a previous frame. Likewise, a first X-axis difference |Xp| between the first input and the second input may be calculated for the previous frame. Then, for a present frame, a second Y-axis difference |Y| and a second X-axis difference |X| may be calculated for a present frame. For the case of drawing the first input and the second input apart along the Y-axis (FIG. 7), the first Y-axis difference |Yp| may be lower than the second Y-axis difference |Y|, whereas the first X-axis difference |Xp| and the second X-axis difference |X| may remain nominally constant or exhibit little variation. For the case of drawing the first input and the second input together along the Y-axis (FIG. 8), the first Y-axis difference |Yp| may be greater than the second Y-axis difference |Y|, whereas the first X-axis difference |Xp| and the second X-axis difference |X| may remain nominally constant or exhibit little variation. For the case of drawing the first input and the second input apart along the X-axis (FIG. 9), the first X-axis difference |Xp| may be lower than the second X-axis difference |X|, whereas the first Y-axis difference |Yp| and the second Y-axis difference |Y| may remain nominally constant or exhibit little variation. For the case of drawing the first input and the second input apart along the X-axis (FIG. 10), the first X-axis difference |Xp| may be greater than the second X-axis difference |X|, whereas the first Y-axis difference |Yp| and the second Y-axis difference |Y| may remain nominally constant or exhibit little variation. In all of the above cases for FIG. 7 to FIG. 10, the midpoint may remain nominally constant or exhibit little variation along both the Y-axis and the X-axis. In other words, the first variation ΔX and the second variation ΔY may be close to zero.

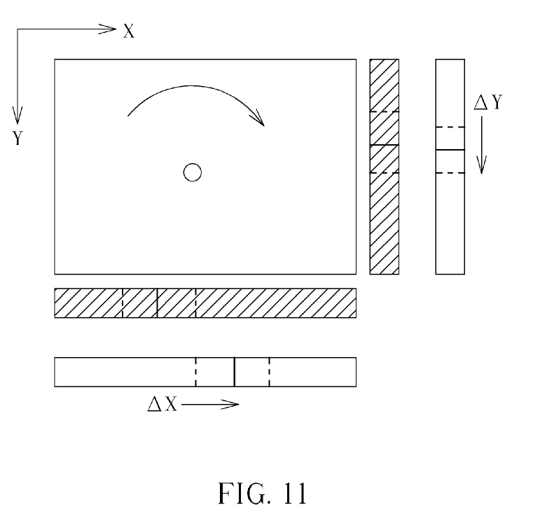

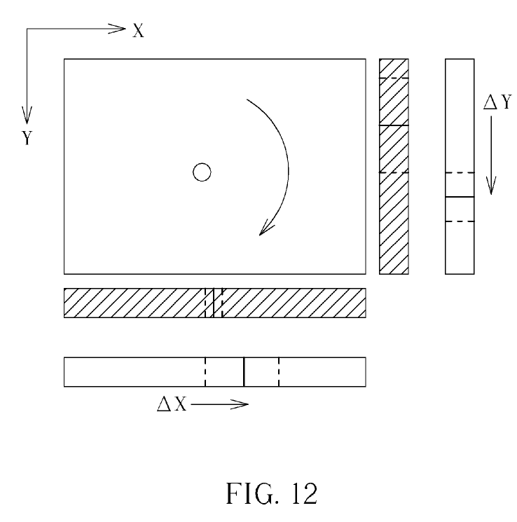

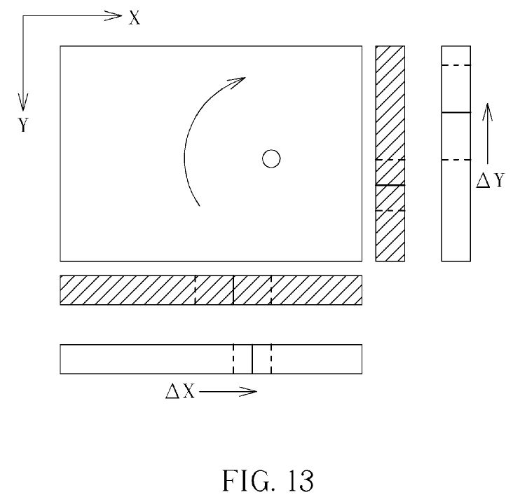

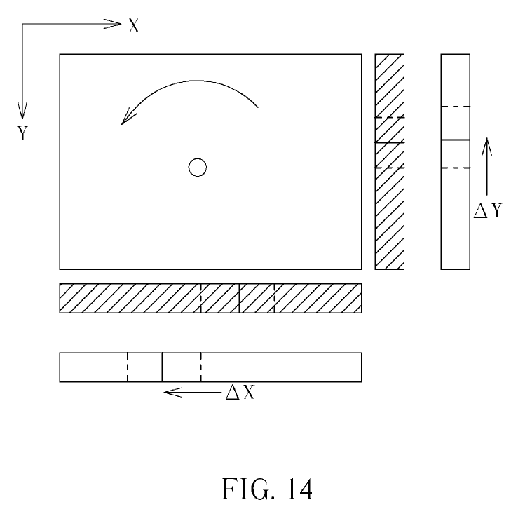

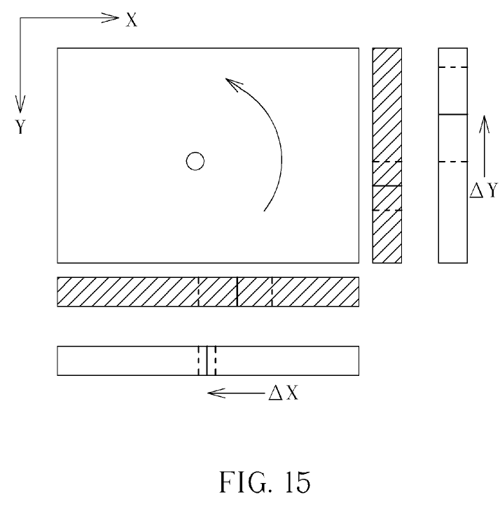

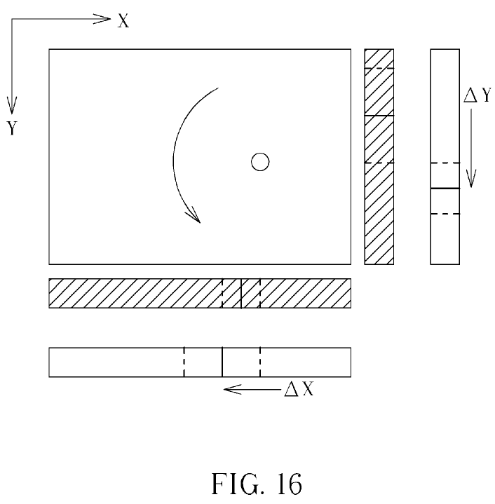

Please refer to FIG. 11 to FIG. 16, which are diagrams illustrating detecting change of position for multiple inputs in a multitouch device through midpoint shifts. As shown in FIG. 11, the first input may remain nominally constant (shown by a circle), whereas the second input may move in clockwise rotation around the first input (shown by an arcing arrow). In this case, the first variation ΔX is positive along the X-axis, and the second variation ΔY but to a lesser degree along the Y-axis. For clockwise rotation as shown in FIG. 12, the second variation ΔY is positive along the Y-axis, and the first variation ΔX is positive along the X-axis. For clockwise rotation as shown in FIG. 13, the second variation ΔY is negative along the Y-axis, and the first variation ΔX is positive along the X-axis. For counter-clockwise rotation as shown in FIG. 14, the second variation ΔY is negative along the Y-axis, and the first variation ΔX is negative along the X-axis. For counter-clockwise rotation as shown in FIG. 15, the second variation ΔY is negative along the Y-axis, and the first variation ΔX is negative along the X-axis. For counter-clockwise rotation as shown in FIG. 16, the second variation ΔY is positive along the Y-axis, and the first variation ΔX is negative along the X-axis.

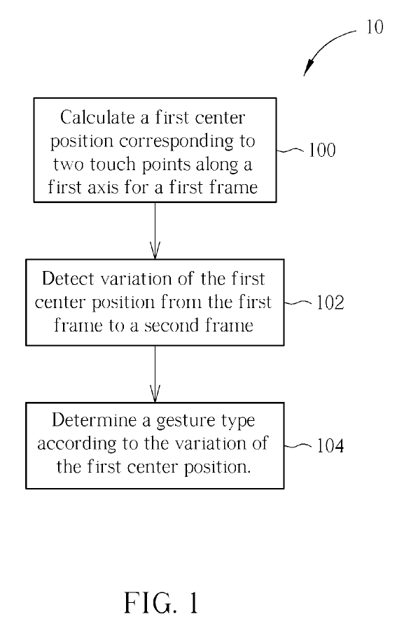

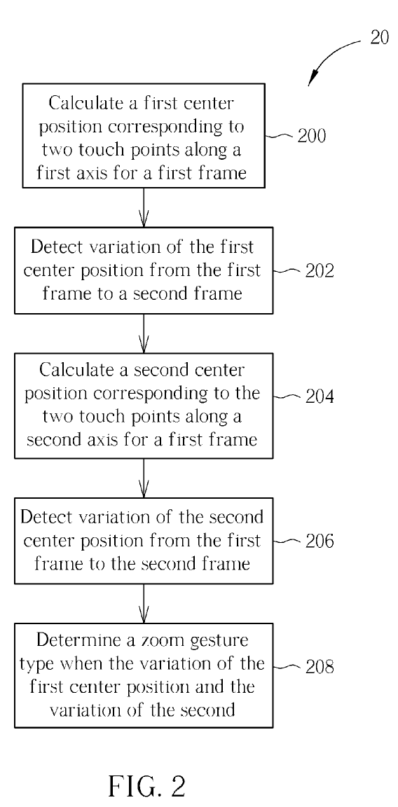

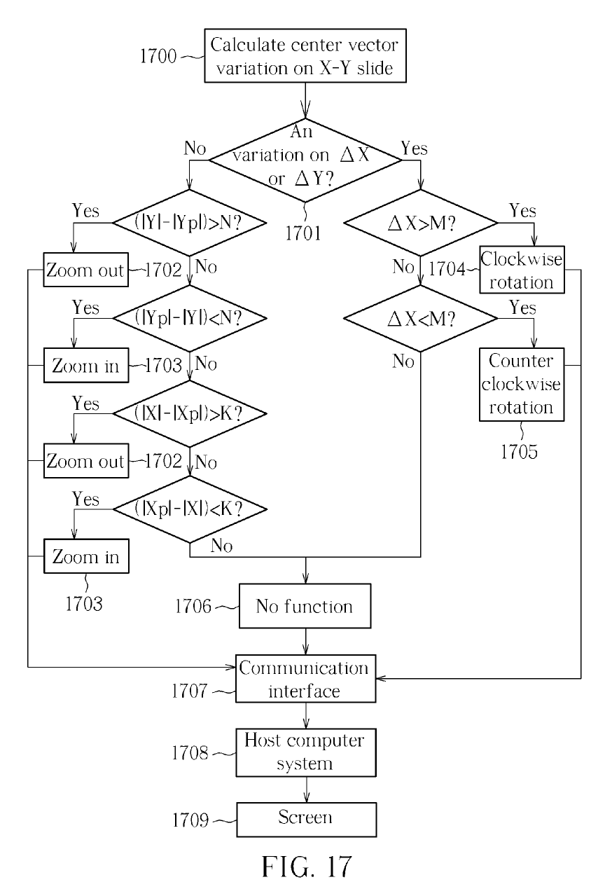

In the following, please refer to FIG. 17 in conjunction with FIG. 1 to FIG. 2. FIG. 17 is a diagram of tracking touch inputs according to an embodiment of the present invention. FIG. 1 is a flowchart of a process 10 for tracking touch inputs according to the embodiment of FIG. 17. The process 10 comprises the following steps:

Step 100: Calculate a first center position corresponding to two touch points along a first axis for a first frame.

Step 102: Detect variation of the first center position from the first frame to a second frame.

Step 104: Determine a gesture type according to the variation of the first center position.

In the process 10, the first frame may be the previous frame, and the second frame may be the present frame, as described above. In FIG. 17, center vector variation is calculated on an X-Y slide (Step 1700), such as the X-axis and the Y-axis shown in FIG. 7 to FIG. 16. The center vector variation may include the X-axis variation ΔX and the Y-axis variation ΔY, and Step 100 to Step 102 of FIG. 1 may be utilized to calculate, for example, the X-axis variation ΔX by calculating the first center position <Xc,Yc> and the second center position <Xc′,Yc′>, and finding a difference between the second center position and the first center position, e.g. ΔX=Xc′−Xc. Likewise, the Y-axis variation ΔY may be calculated as ΔY=Yc′−Yc. Then, utilizing the X-axis variation ΔX, the gesture type may be determined (Step 104), which is shown as clockwise rotation (Step 1704) or counter-clockwise rotation (Step 1705) in FIG. 17. For example, if the X-axis variation ΔX is greater than a predetermined variation M, clockwise rotation may be determined (Step 1704). On the other hand, if the X-axis variation ΔX is less than the predetermined M, counter-clockwise rotation may be determined (Step 1705). Then, the determined rotation, i.e. the clockwise rotation or the counter-clockwise rotation, may be shown on a screen 1709 via a communication interface 1707 and a host computer system 1708.

Please refer to FIG. 2, which is a flowchart of a second process 20 for tracking touch inputs according to the embodiment of FIG. 17. The second process 20 may be utilized in conjunction with the process 10, and comprises the following steps:

Step 200: Calculate a first center position corresponding to two touch points along a first axis for a first frame.

Step 202: Detect variation of the first center position from the first frame to a second frame.

Step 204: Calculate a second center position corresponding to the two touch points along a second axis for a first frame.

Step 206: Detect variation of the second center position from the first frame to the second frame.

Step 208: Determine a zoom gesture type when the variation of the first center position and the variation of the second position are both lower than a predetermined threshold.

In the second process 20, the first frame may be the previous frame, and the second frame may be the present frame, as described above. In FIG. 17, center vector variation is calculated on an X-Y slide (Step 1700), such as the X-axis and the Y-axis shown in FIG. 7 to FIG. 16. The center vector variation may include the X-axis variation ΔX and the Y-axis variation ΔY, and Step 200 to Step 206 of FIG. 2 may be utilized to calculate, for example, the X-axis variation ΔX by calculating the first center position <Xc,Yc> and the second center position <Xc′,Yc′>, and finding a difference between the second center position and the first center position, e.g. ΔX=Xc′−Xc. Likewise, the Y-axis variation ΔY may be calculated as ΔY=Yc′−Yc. Then, if little or no variation is detected on the X-axis variation ΔX and the Y-axis variation ΔY, the zoom gesture type may be determined (Step 208; Step 1702 to Step 1703). As shown in FIG. 17, if the first Y-axis difference |Yp| is less than the second Y-axis difference |Y| by a predetermined variation threshold N, the zoom out gesture is determined (Step 1702). Likewise, if the first X-axis difference |Xp| is less than the second X-axis difference |X| by a predetermined variation threshold K, the zoom out gesture is determined (Step 1702). On the other hand, if the first Y-axis difference |Yp| is greater than the second Y-axis difference |Y| by the predetermined variation threshold N, the zoom in gesture is determined (Step 1703). Likewise, if the first X-axis difference |Xp| is greater than the second X-axis difference |X| by the predetermined variation threshold K, the zoom in gesture is determined (Step 1703). Then, the determined zoom gesture, i.e. the zoom in gesture or the zoom out gesture, may be shown on the screen 1709 via the communication interface 1707 and the host computer system 1708.

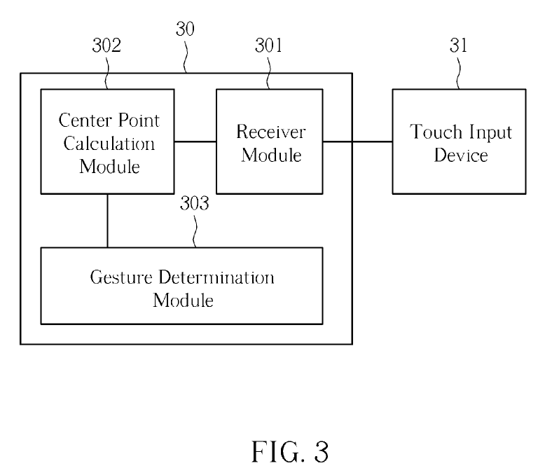

Please refer to FIG. 3, which is a diagram of a touch input tracking device 30, which may be utilized to interface with a touch input device 31 for tracking touch inputs and determining gesture type. The touch input tracking device 30 comprises a receiving module 301, a center point calculation module 302, and a gesture determination module 303. The receiving module 301 receives the first frame and the second frame from the touch input device 31. The center point calculation module 302 calculates the first center point and the second center point of two touch points in the first frame and the second frame. The first center point corresponds to a first axis, such as the X-axis, and the second center point corresponds to a second axis, such as the Y-axis. The gesture determination module 302 determines a gesture type according to variation, e.g. the X-axis variation ΔX, of the first center point from the first frame to the second frame, and variation, e.g. the Y-axis variation ΔY, of the second center point from the first frame to the second frame.

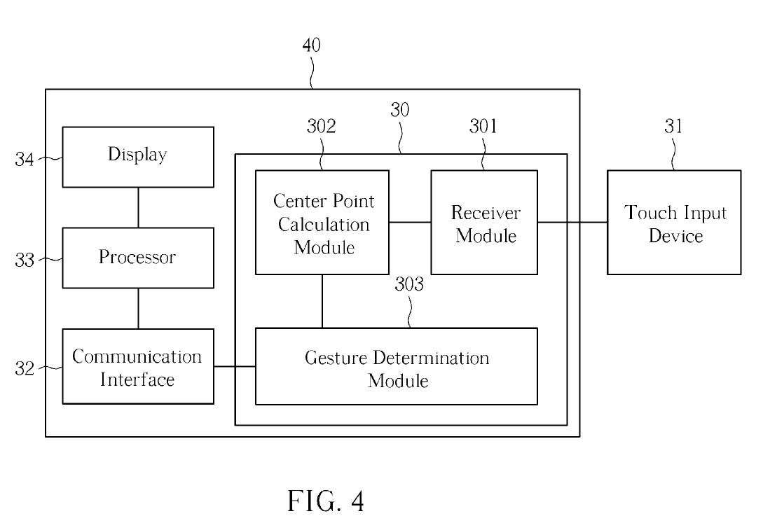

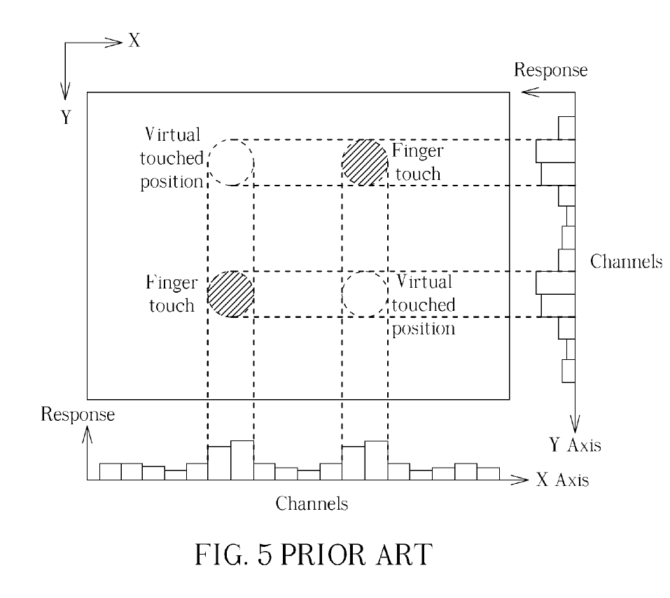

Please refer to FIG. 4, which is a diagram of a computer system 40, which may be utilized to interface with the touch input device 31. In addition to the touch input tracking device 30 described above, the computer system 40 further comprises a communication interface 32, a processor 33, and a display 34. The communication interface 32 receives the gesture type from the gesture determination module 303. The processor 33 modifies an image according to the gesture type and drives the display 34 to display the image. The display 34 may display the image before modification, or a modified image resulting from the processor 33 modifying the image.

Those skilled in the art will readily observe that numerous modifications and alterations of the device and method may be made while retaining the teachings of the invention.

What is claimed is:

1. A method of tracking touch inputs, the method comprising:
calculating a first center position corresponding to two touch points along a first axis for a first frame;
detecting variation of the first center position from the first frame to a second frame; and
determining a gesture type according to the variation of the first center position.

2. The method of claim 1, wherein determining the gesture type according to the variation of the first center position comprises determining a rotation when the variation of the first center position is greater than a predetermined rotation threshold.

3. The method of claim 1, further comprising:
calculating a second center position corresponding to the two touch points along a second axis for the first frame;
detecting variation of the second center position from the first frame to the second frame; and
determining a rotation direction of the gesture type according to the variation of the first center position and the variation of the second center position.

4. The method of claim 3, wherein determining the rotation of the gesture type according to the variation of the first center position and the variation of the second center position comprises determining the rotation of the gesture type according to polarities of the variation of the first center position and the variation of the second center position.

5. The method of claim 4, wherein determining the rotation of the gesture type according to the variation of the first center position and the variation of the second center position comprises determining clockwise rotation when the variation of the first center position is greater than zero.

6. The method of claim 4, wherein determining the rotation of the gesture type according to the variation of the first center position and the variation of the second center position comprises determining counter-clockwise rotation when the variation of the first center position is less than zero.

7. A method of tracking touch inputs, the method comprising:
calculating a first center position corresponding to two touch points along a first axis for a first frame;
detecting variation of the first center position from the first frame to a second frame;
calculating a second center position corresponding to the two touch points along a second axis for a first frame;
detecting variation of the second center position from the first frame to the second frame; and
determining a zoom gesture type when the variation of the first center position and the variation of the second position are both lower than a predetermined threshold.

8. The method of claim 7, wherein determining the zoom gesture type comprises determining a zoom out gesture when a first distance variation of the two touch points corresponding to the first frame along the first axis is greater than a second distance variation of the two touch points corresponding to the second frame along the first axis by a predetermined zoom threshold.

9. The method of claim 7, wherein determining the zoom gesture type comprises determining a zoom out gesture when a first distance variation of the two touch points corresponding to the first frame along the second axis is greater than a second distance variation of the two touch points corresponding to the second frame along the second axis by a predetermined zoom threshold.

10. The method of claim 7, wherein determining the zoom gesture type comprises determining a zoom in gesture when a first distance variation of the two touch points corresponding to the first frame along the second axis is less than a second distance variation of the two touch points corresponding to the second frame along the second axis by a predetermined zoom threshold.

11. The method of claim 7, wherein determining the zoom gesture type comprises determining a zoom in gesture when a first distance variation of the two touch points corresponding to the first frame along the second axis is less than a second distance variation of the two touch points corresponding to the second frame along the second axis by a predetermined zoom threshold.

12. A touch input tracking device comprising:
a receiving module for receiving a first frame and a second frame;
a center point calculation module for calculating a first center point and a second center point of two touch points in the first frame and the second frame, the first center point corresponding to a first axis and the second center point corresponding to a second axis; and
a gesture determination module for determining a gesture type according to variation of the first center point from the first frame to the second frame, and variation of the second center point from the first frame to the second frame.

13. A computer system comprising:
a touch input tracking device comprising:
a receiving module for receiving a first frame and a second frame;
a center point calculation module for calculating a first center point and a second center point of two touch points in the first frame and the second frame, the first center point corresponding to a first axis and the second center point corresponding to a second axis; and
a gesture determination module for determining a gesture type according to variation of the first center point from the first frame to the second frame, and variation of the second center point from the first frame to the second frame;
a communication interface for receiving the gesture type from the gesture determination module;
a display; and
a processor for modifying an image according to the gesture type and driving the display to display the image.
